(19) United States
(12) Patent Application Publication
(10) Pub. No.: US 2006/0059019 A1
(43) Pub. Date: Mar. 16, 2006

(54) Medical order management system and user interface

(76) Inventors: Tobias Komischke, Phoenixville, PA (US); Theresa M. Miller, Downingtown, PA (US); Harm J. Scherpbier, Fort Washington, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/128,021

(22) Filed: May 12, 2005

Related U.S. Application Data
(60) Provisional application No. 60/610,289, filed on Sep. 16, 2004.

(51) Int. Cl. G06F 19/00

(52) U.S. Cl. 705/3

(57) ABSTRACT

A physician order entry user interface system facilitates resolution of a problem associated with an order for a treatment to be administered to a patient. A user interface system for use in managing orders for providing treatment for a patient, includes a display processor for initiating generation of data representing a display image. The display image includes, a first user selectable image element indicating an order for a particular treatment to be provided to a particular patient is to be retained and a second user selectable image element indicating the order for the particular treatment to be provided to the particular patient is to be revoked. An order processor updates stored order representative records to indicate the order for the particular treatment to be provided to the particular patient is cancelled in response to user selection of the second user selectable image element.

This is a non-provisional application of provisional application Ser. No. 60/610,289 by T. Komischke filed Sep. 16, 2004.

### FIELD OF THE INVENTION

This invention concerns a user interface system for use in managing orders for providing treatment for a patient.

### BACKGROUND INFORMATION

A problem may occur during the processing of a physician initiated order for providing treatment services to a patient using a computerized order entry and processing system. A problem may arise, for example, if patient circumstances change, a potential drug interaction is discovered following order placement or an order is superseded by a later order. One resolution action that may be taken to address such a problem is to either stop the order and/or affected associated orders (if there are any). An existing system differentiates orders by whether or not affected orders are already signed, so the resolution action could be either “Discontinue Order X” (if the order was already signed) or “Don't place order Y” (if the order was not yet signed). Alternatively an order may be revoked. Existing user interface systems lack an overview display image showing a comprehensive view of affected orders and fail to provide a user friendly interface. This leads to poor usability and user dissatisfaction.

Existing order entry user interface images also fail to provide image windows facilitating an order entry, edit and correction process. Existing user interface systems lack a flexible user friendly presentation and associated image navigation method, concurrently supporting current orders, existing orders and order selection for a specific patient. A system according to invention principles addresses these deficiencies and associated problems.

### SUMMARY OF THE INVENTION

A physician order entry user interface system supports concurrent management of current signed orders for administration to a patient, editing of new orders awaiting signature to become current signed orders and order selection lists identifying order available for selection as well as resolution of problem orders that need to be cancelled, for example. A user interface system for use in managing orders for providing treatment for a patient, includes a display processor for initiating generation of data representing a display image. The display image includes, a first user selectable image element indicating an order for a particular treatment to be provided to a particular patient is to be retained and a second user selectable image element indicating the order for the particular treatment to be provided to the particular patient is to be revoked. An order processor updates stored order representative records to indicate the order for the particular treatment to be provided to the particular patient is cancelled in response to user selection of the second user selectable image element.

### BRIEF DESCRIPTION OF THE DRAWING

FIG. 1 shows a networked healthcare information system employing a physician order entry system and user interface supporting management of current signed treatment orders and new unsigned treatment orders as well as resolution of problem orders, according to invention principles.

FIG. 2-7 show user interface images employed by the physician order entry user interface system of FIG. 1 for resolving problem orders, according to invention principles.

FIG. 8-10 show user interface images employed by the physician order entry user interface system supporting current signed treatment order and new unsigned treatment order management, according to invention principles.

FIG. 11 shows a flowchart of a process supporting current signed treatment order and new unsigned treatment order management as well as resolution of problem orders, according to invention principles.

### DETAILED DESCRIPTION OF INVENTION

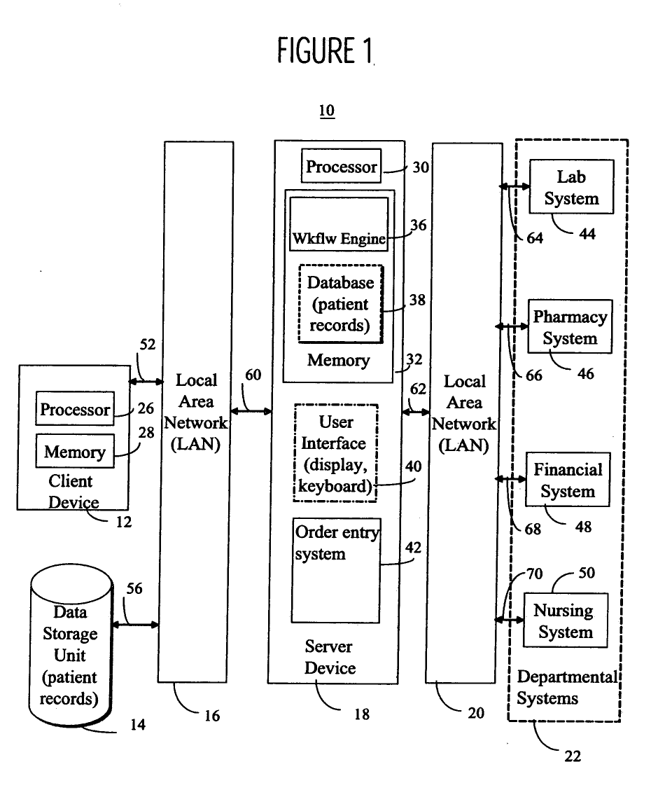

FIG. 1 shows a networked hospital information system employing a physician order entry user interface system for managing current signed treatment orders and new unsigned treatment orders as well as resolution of problem orders. The user interface system allows users to quickly determine what clinical problems are associated with one or more treatment orders they selected to be signed for a patient. Alert messages generated in response to physician selection of a treatment order for a patient and patient clinical information, may be complex because a large number of other orders may have to be examined, e.g. due to drug to drug interactions. Furthermore, there are several resolution actions that may need to be implemented in the event of a generated alert message. The system addresses the problem of providing required information structured so that the information does not overwhelm a user and advantageously concisely presents the information in an image area of reduced size. The system may seamlessly combine and process multiple different alerts.

A user interface system according to invention principles addresses the problems of showing crucial information whilst facilitating access to more detailed information. The system also addresses the problem of presenting available resolution action options including a “Revoke” command enabling a user to revoke a treatment order, for example, in a way that the user quickly comprehends. For a selected order, the system presents image elements identifying clinical alerts that may be associated with the order. The system advantageously captures and focuses user attention on a desired location within an image and provides relevant descriptive information concerning a problem (e.g., related to a clinician initiated order). The system provides a display image that identifies available potential problem resolution action options and allows users to hide or show several layers of information. The system advantageously identifies and indicates resolution actions to a user in a display image using a visual pattern approach. A user establishes a visual pattern by selecting either a left or right radio button representing commands to keep or revoke a treatment order, for example. When a user reviews the selections, a visual pattern makes it easy for the user to perceive what command selections have been chosen.

An executable application as used herein comprises code or machine readable instruction for implementing predetermined functions including those of an operating system, healthcare information system or other information processing system, for example, in response user command or input. An executable procedure is a segment of code (machine readable instruction), sub-routine, or other distinct section of code or portion of an executable application for performing one or more particular processes and may include performing operations on received input parameters (or in response to received input parameters) and provide resulting output parameters. A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device.

FIG. 1 shows a networked healthcare information system 10 employing a physician order entry system (order processor) 42 and user interface 40 supporting management of current signed treatment orders and new unsigned treatment orders as well as resolution of problem orders. Healthcare information system 10 includes a client device 12, a data storage unit 14, a first local area network (LAN) 16, a server device 18, a second local area network (LAN) 20, and departmental systems 22. The client device 12 includes processor 26 and memory unit 28 and may comprise a personal computer, for example. The healthcare information system 10 is used by a healthcare provider that is responsible for monitoring the health and/or welfare of people in its care. Examples of healthcare providers include, without limitation, a hospital, a nursing home, an assisted living care arrangement, a home health care arrangement, a hospice arrangement, a critical care arrangement, a health care clinic, a physical therapy clinic, a chiropractic clinic, and a dental office. Examples of the people being serviced by the healthcare provider include, without limitation, a patient, a resident, and a client.

Physician order entry system 42 manages current signed treatment orders and new unsigned treatment orders as well as resolution of problem orders in conjunction with user interface system 40. User interface system 40 provides a Current Orders Pane (COP) image window identifying already signed orders initiated by a physician, a Current Ordering Session (COS) image window identifying new orders that are to be signed to become current orders and which may or may not be edited and a selection list (e.g., Picklist) image window identifying available treatment orders selectable to become new orders in a COS image window. The system advantageously concurrently displays at least two of the COP, COS and Picklist image windows in a single composite image. Existing user interface systems lack a flexible user friendly presentation and associated image navigation method that concurrently supports current orders, existing orders and order selection for a specific patient. Existing systems typically show COP, COS or Picklist image windows individually, one at a time, so the data is presented sequentially. Further, in existing systems, a user is deprived of an overview of COP, COS and Picklist image windows and is burdened by the need to memorize substantial quantities of data in navigating order entry menus to create a desired treatment order for a particular patient.

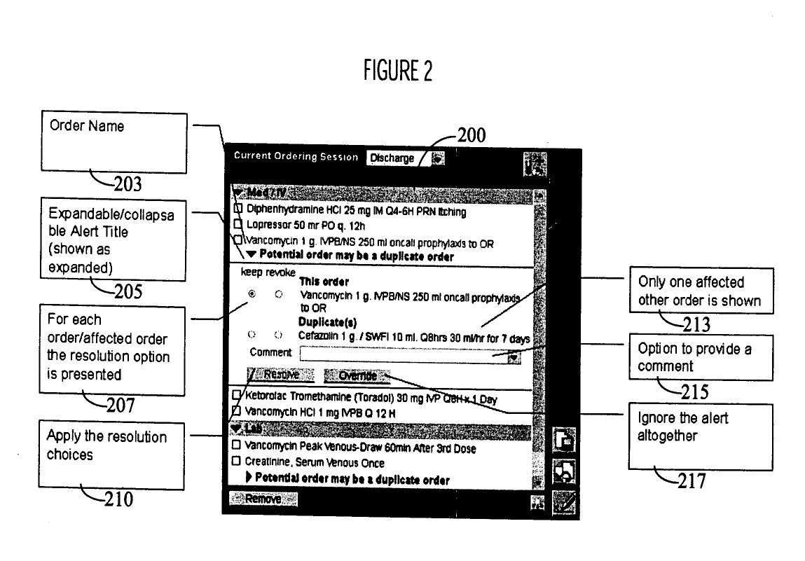

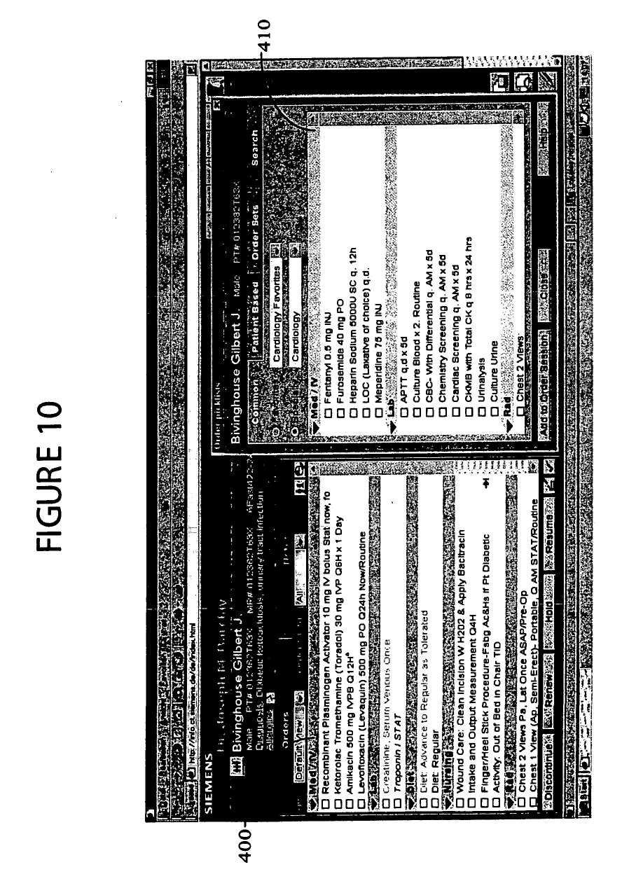

Physician order entry system 42 in conjunction with user interface system 40 provides the user interface images of FIGS. 2-9 and employs the process of FIG. 10. In another embodiment one or more of system 42, user interface system 40 and workflow engine 36 may be located in client device 12. User interface system 40 includes an input device that permits a user to provide information to client device 12 and an output device that provides a user a display of image menus and other information. Preferably, the input device is a keyboard and mouse, but also may be a touch screen or a microphone with a voice recognition program, or a telephone voice response system for example. The output device is a display. The output device provides information to the user responsive to the input device receiving information from the user or responsive to other activity by client device 12. For example, the display presents information responsive to the user entering information in the client device 12 via a keyboard.

Physician order entry system 42 and user interface system 40 provide the user interface images of FIG. 2-7 enabling a user to resolve problem orders. The image window 200 of FIG. 2 enables a user to resolve problems with an order for treatment selected by a physician, for example. A treatment order 203 identified by an order name (here Vancomycin) has a problem and is highlighted in a different color (e.g., using a red font). An alert title 205 associated with order 203 is presented in another line of text and provides significant information about the problem. Alert title 205 comprises an expandable blind which is expandable (and subsequently collapsible) in response to user action to provide a physician, for example, with information identifying potential problem resolution options together with more detailed information. The expanded alert title in this example shows one other affected treatment order 213 indicating a potential duplicate order of Cefazolin. The expanded alert title enables a physician to individually keep or revoke, either or both the Vancomycin and Cefazolin orders, e.g., via option button 207. A user initiates a selected keep or revoke action via activation of resolve button 210. A physician is able to enter a comment concerning the alert via comment box 215 or to ignore and override the alert via button 217. The interface system advantageously improves presentation and management of treatment order problems via the FIG. 2 image overview and facilitates physician problem understanding with efficient use of image real estate.

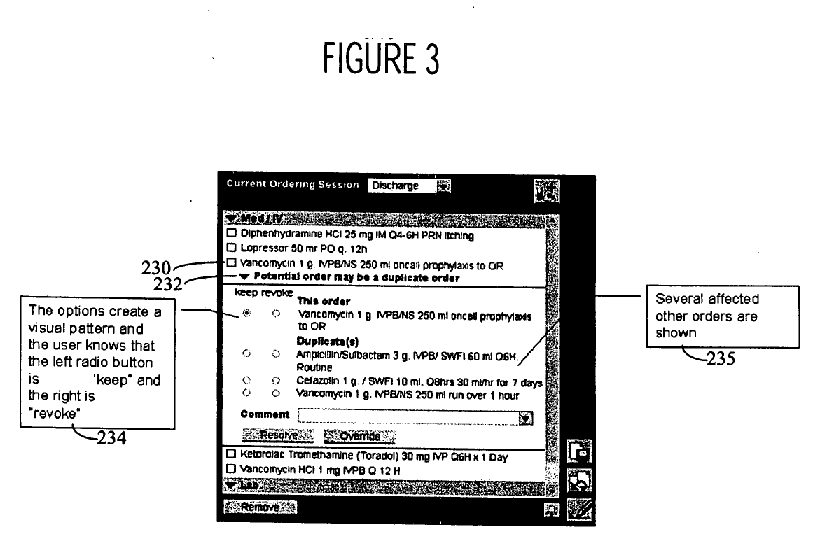

The image window of FIG. 3 shows treatment order 230 identified by an order name (here Vancomycin) that has a problem and is highlighted in a different color (e.g., using a red font). Alert title 232 associated with order 230 is shown expanded to provide a physician with information identifying potential problem resolution options together with more detailed information. Specifically, expanded alert title 232 shows the Vancomycin order together with three potentially affected other orders 235. These other orders comprise potential duplicate orders for Ampicillin, Cefazolin and another Vancomycin order. These orders are indicated together with physician selectable keep and revoke options for each treatment order. The keep and revoke selection options are advantageously shown using a consistent visual pattern 234. Thereby, a physician knows that a left option (radio) button consistently enables a keep order action and a right option button consistently enables a revoke order action.

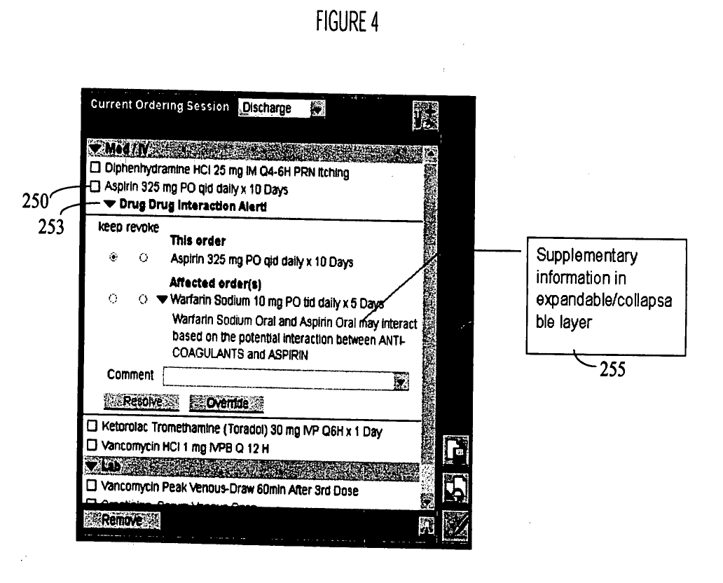

The image window of FIG. 4 shows treatment order 250 identified by an order name (here Aspirin) that has a problem and is highlighted in a different color (e.g., using a red font). Alert title 253 associated with order 250 is shown expanded to show the Aspirin order together with a potentially affected other order for Warfarin. The potentially affected Warfarin order is advantageously presented as an expandable (and subsequently collapsible) image area 255 within the expanded Alert title 253. The image area 255 is expanded in response to user selection and provides supplementary information concerning a potential problem drug interaction of the previously initiated Warfarin order with the physician selected order for Aspirin.

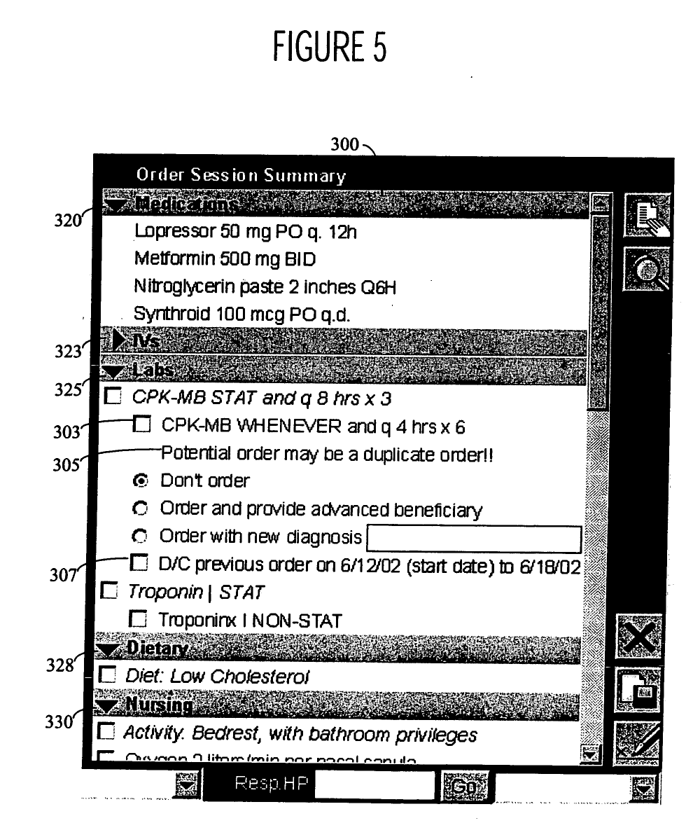

The image window of FIG. 5 shows an embodiment of a treatment order image window that does not use an expandable (and subsequently collapsible) alert title blind. Treatment order mage window 300 presents clinician selected treatment orders categorized by function including medication orders 320, Intra-Venous infusion orders 323, Laboratory orders 325, dietary orders 328 and nursing orders 330. Laboratory treatment order 303 identified by an order name (here CPK-MB) has a problem and is highlighted in a different color (e.g., using a red font). Non-expandable alert title 305 associated with order 303 is accompanied by three subsequent rows of user selectable problem resolution actions and an indication 307 that there exists a potential previous order which may be a problem. The problem resolution actions enable a user to resolve the order problem by not initiating the CPK-MB order or by initiating the order whilst providing an advanced beneficiary notice. An “Advance Beneficiary Notice” (ABN) is generated when a Medicare patient, for example, is provided with a service that is known or could reasonably be expected to be known is not medically necessary and reasonable as established by a Medicare carrier. The ABN is provided to notify the patient in writing before performing the service the reasons Medicare claim denial may be expected. Without a properly signed ABN, a service denied as not medically necessary and reasonable and cannot be billed to the patient.

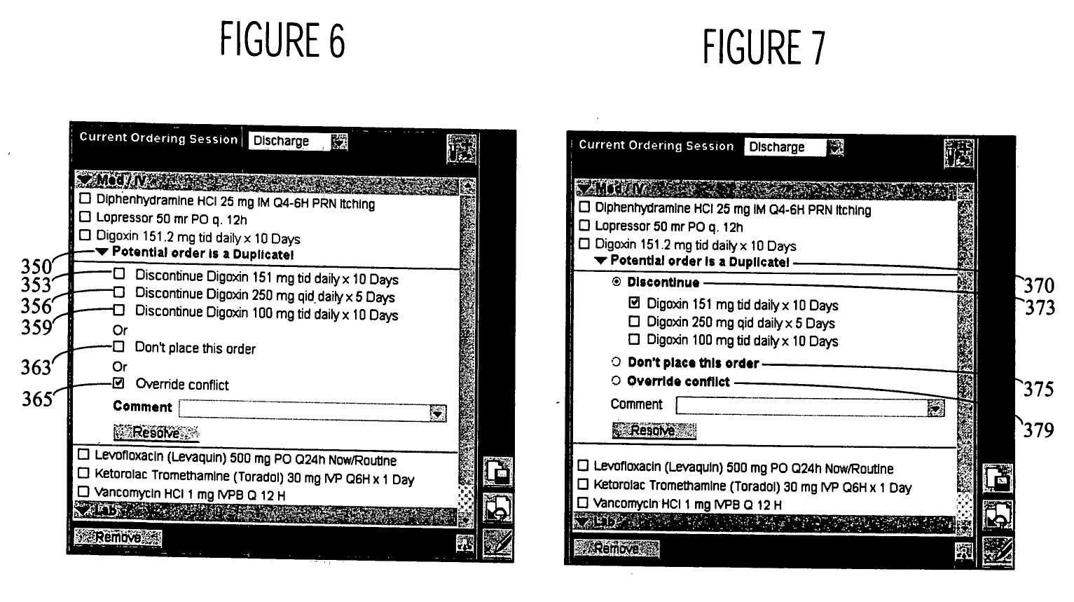

The image windows of FIGS. 6 and 7 show different treatment order problem resolution options available to a user in expandable alert titles 350 and 370 respectively. In the image window of FIG. 6, a user is presented, in expanded alert title 350, with options 353, 356 and 359 enabling a user to discontinue particular treatment orders together with option 363 enabling a user to inhibit initiating an order and option 365 enabling a user to override the conflict alert. In the image window of FIG. 7, a user is presented, in expanded alert title 370, with option 373 enabling a user to discontinue particular treatment orders together with option 375 enabling a user to inhibit initiating an order and option 379 enabling a user to override the conflict alert. The user interface images of FIG. 2-7 provided by user interface system 40 advantageously enable configuration of user interface elements (expandable/collapsible blinds, radio buttons, etc.), for use in fields other than healthcare.

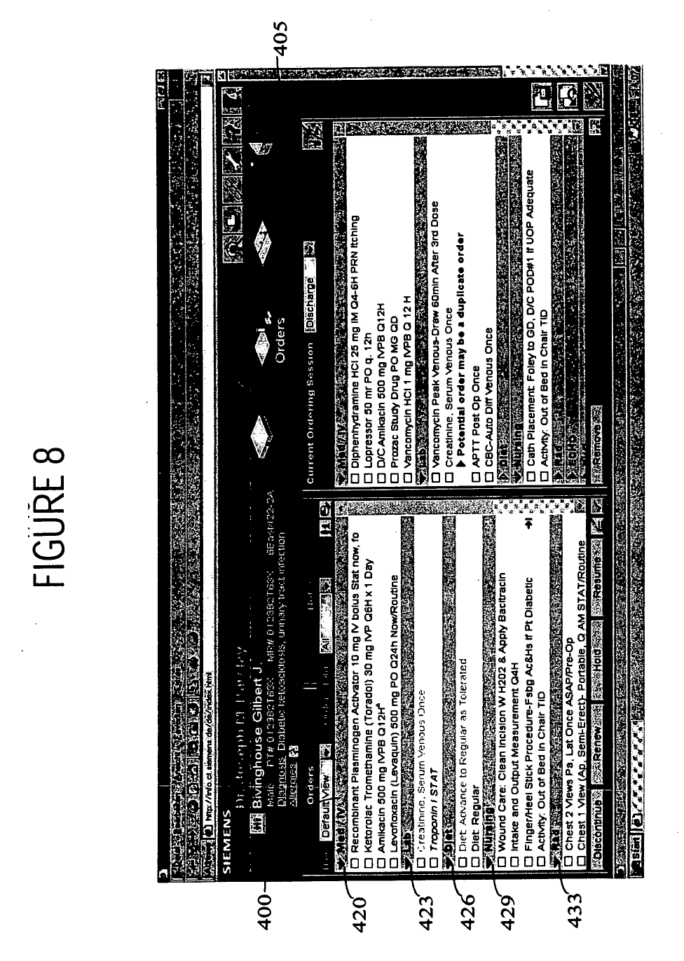

Physician order entry system 42 and user interface system 40 provide the user interface images of FIG. 8-10 supporting advantageous physician order entry functions. The user interface images of FIG. 8-10 support management of current signed treatment orders and new unsigned treatment orders. The image of FIG. 8 comprises an image vertically separated into two image windows 400 and 405 of approximately equal size comprising a composite image. Image window 400 shows a Current Orders Pane (COP) image window identifying already signed orders initiated by a physician for a specific patient. Treatment orders are arranged in categories comprising medication orders 420, laboratory orders 423, dietary orders 426, nursing orders 429 and radiology orders 433, for example. Image window 405 shows a Current Ordering Session (COS) image window identifying new orders that are to be signed to become current orders and which may or may not be edited (e.g. due to alerts that are triggered by system 10).

The COP image window 400 advantageously provides a user with a quick overview of treatment orders that are currently ordered for a patient and their status (e.g., active, discontinued). Physician order entry system 42 and user interface system 40 presents the user with COP image window 400 in response to user login to view information concerning a specific patient, for example. The COS image window 405 presents a user with data indicating treatment orders available to be signed, edited and added to the currently ordered treatment orders in window 400. The COS image window 405 is analogous to a treatment order shopping cart. The system advantageously enables a user to concurrently see current signed orders in image window 400 and available orders in window 405 and helps the user to determine necessary order changes and to amend new orders that are still in edit mode. In response to a change in status of treatment orders in COP image window 400, physician order entry system 42 advantageously transfers the respective orders to COS image window 405 and checks them for validity. Further, the composite image of FIG. 8 advantageously presents image windows 400 and 405 in parallel to facilitate user tracking of a treatment order between the windows.

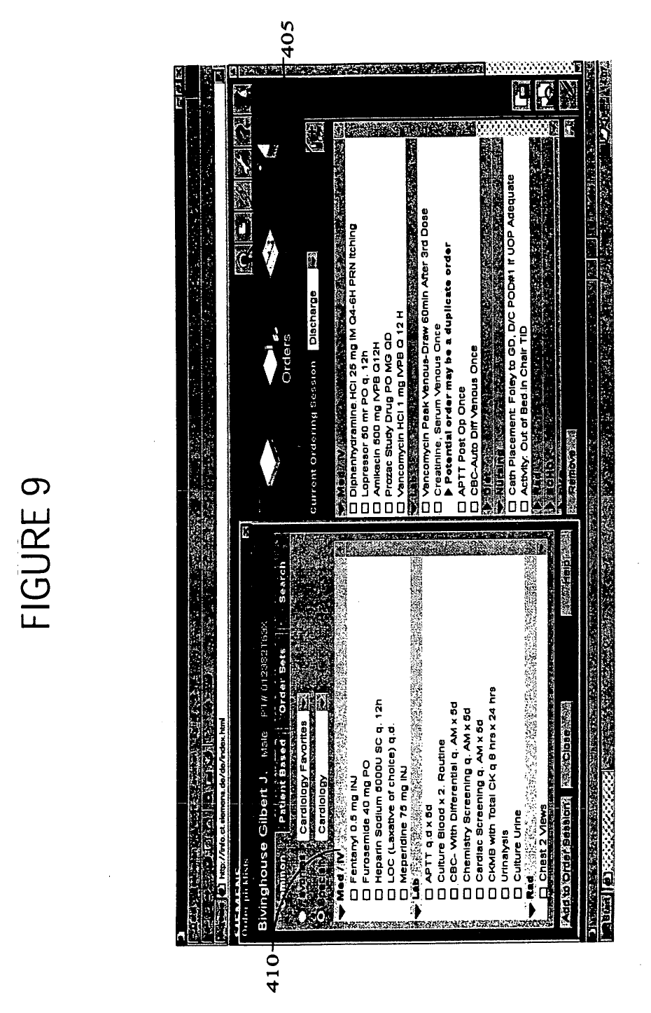

The image of FIG. 9 comprises an image vertically separated into two image windows 410 and 405 of approximately equal size comprising a composite image. Image window 410 in the FIG. 9 image, overlays COP image window 400 and is a selection list (e.g., Picklist) image window identifying available treatment orders selectable to become new orders in COS image window 405. Picklist image window 410 is advantageously provided as a dialog menu that may be positioned by a user via drag and drop control and may overlay COP image window 400 or COS image window 405, for example. Further, Picklist image window 410 is advantageously arranged to have a width substantially approximately half the size of a full image and substantially approximately the same size as COP image window 400 or COS image window 405. User interface system 40 in one embodiment allows a user to concurrently view two (and in another embodiment all three) of the image windows 400, 405 and 410 in a composite image window. This enables a user to readily identify treatment order problems occurring during a current ordering activity within a task sequence of a treatment order entry workflow. A user finds and selects a new treatment order using Picklist image window 410. The FIG. 9 composite image advantageously enables a user to view the COS treatment order shopping cart of image window 405 concurrently with Picklist image window 410 and to determine those orders the user has already selected from the Picklist and to edit the shopping cart orders.

The image of FIG. 10 comprises an image vertically separated into two image windows 400 and 410 of approximately equal size comprising a composite image. Picklist image window 410 overlays COS image window 405 in the FIG. 9 image. A user finds and selects a new treatment order using Picklist image window 410. The FIG. 10 composite image window including windows 410 and 400 advantageously enables a user to view current orders already placed for a particular patient together with a treatment order Picklist to ensure that a selected treatment order is not a duplicate of an already placed order. The composite image window also alerts a user of a need to anticipate interaction effects with current orders, e.g. drug-to-drug interactions. User interface system 40 allows a user to concurrently view two (or more of) image windows 400, 405 and 410. Each combination provides advantageous ordering features for corresponding specific treatment ordering activities during a treatment ordering workflow.

In another embodiment, one of the COP and COS image windows 400 and 405, overlays the other. In the typical case that image windows 400 and 405 contain a large number of line items, it is advantageous if the image window height exceeds the width (and is vertically scrollable). In a further embodiment, COP and COS image windows 400 and 405 are integrated into one image window having two subsections. In an additional embodiment, the COP, COS and Picklist image windows 400, 405 and 410 respectively are integrated into one dialog image window. Integrating image windows in this manner limits the scope of a display overview of signed and unsigned treatment orders and increases the navigation actions (and burden) involved in scrolling and accessing image window line items.

Returning to the networked healthcare information system of FIG. 1, server device 18 includes processor 30, a memory unit 32 including workflow engine 36 and a database 38 containing patient records. Server device 18 may be implemented as a personal computer or a workstation. Database 38 provides a location for storing patient records and data storage unit 14 provides an alternate store for patient records, as well as other information for hospital information system 10. The information in data storage unit 14 and database 38 is accessed by multiple users from multiple client devices. Patient records may be accessed from memory unit 28 in client device 12, or in memory units in the departmental systems 22. Patient records in data storage unit 14 include information related to a patient including, without limitation, biographical, financial, clinical, workflow, care plan and patient encounter (visit) related information.

The first local area network (LAN) 16 (FIG. 1) provides a communication network among the client device 12, the data storage unit 14 and the server device 18. The second local area network (LAN) 20 provides a communication network between the server device 18 and the departmental systems 22. Departmental systems 22 include laboratory system 44, a pharmacy system 46, a financial system 48 and a nursing system 50 and may also include a records system, a patient administration system, a radiology system, an accounting system, a billing system, and any other system required or desired in a healthcare information system. The first LAN 16 and the second LAN 20 may be the same or different LANs, depending on the particular network configuration and the particular communication protocols implemented. Alternatively, one or both of the first LAN 16 and the second LAN 20 may be implemented as a wide area network (WAN).

The communication paths 52, 56, 60, 62, 64, 66, 68 and 70 permit the various elements, shown in FIG. 1, to communicate with the first LAN 16 or the second LAN 20. Each of the communication paths 52, 56, 60, 62, 64, 66, 68 and 70 are preferably adapted to use one or more data formats, otherwise called protocols, depending on the type and/or configuration of the various elements in the healthcare information systems 10. Examples of the information system data formats include, without limitation, an RS232 protocol, an Ethernet protocol, a Medical Interface Bus (MIB) compatible protocol, DICOM protocol, an Internet Protocol (I.P.) data format, a local area network (LAN) protocol, a wide area network (WAN) protocol, an IEEE bus compatible protocol, and a Health Level Seven (HL7) protocol.

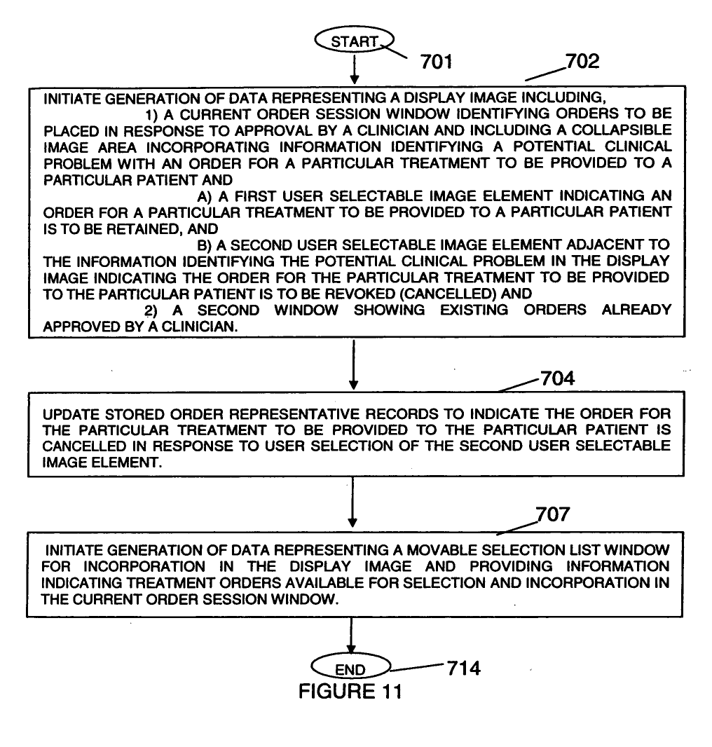

FIG. 11 shows a flowchart of a process performed by physician order entry system 42 in conjunction with user interface system 40 supporting current signed treatment order and new unsigned treatment order management as well as resolution of problem orders. In step 702 following the start at step 701, system 42 and 40 initiate generation of data representing a display image including a current order session window identifying orders to be placed in response to approval by a clinician and including a collapsible image area including information identifying a potential clinical problem with an order for a particular treatment to be provided to a particular patient. The potential problem indicates at least one of, (a) an order replication, (b) a medication dosage problem, (c) a medication interaction problem, (d) an inconsistency between patient medical data and prescribed medication, (e) a less expensive equivalent order and (f) a recommendation for use of an alternative medication in view of a shortage, for example.

The current order session window includes a first user selectable image element indicating an order for a particular treatment to be provided to a particular patient is to be retained and a second user selectable image element indicating the order for the particular treatment to be provided to the particular patient is to be revoked (cancelled). The first and second user selectable image elements are adjacent to each other and adjacent to the information identifying the potential clinical problem. The display image includes a second window showing existing orders already approved by a clinician. The current order session window and the second window are adjacent in the display image and each occupy substantially half the width of the available display image width.

System 42 and 40 initiate generation of data representing the display image including the first and second user selectable image elements in response to user selection of a third image element in a different second image. The third image element also initiates expansion of the collapsible image area to show the display image identifying a potential clinical problem with the order. The display image includes a fourth image element indicating the collapsible image area is in a collapsed or expanded, state. The collapsible image area is labeled to indicate existence of a potential clinical problem with the order for the particular treatment to be provided to the particular patient.

In step 704, system 42 updates stored order representative records to indicate the order for the particular treatment to be provided to the particular patient is cancelled in response to user selection of the second user selectable image element in the display image. In step 707, system 42 and 40 initiate generation of a movable selection list window for incorporation in the display image and providing information indicating treatment orders available for selection and incorporation in the current order session window. The current order session window and the selection list window are adjacent in the display image. The current order session window and the selection list window each occupy substantially half the width of the available display image width. Machine readable instruction for executing the steps of FIG. 11 may be incorporated in a tangible storage medium. The process of FIG. 11 terminates at step 714.

The system, processes and user interface display images presented herein are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, any of the functions provided by the system and process of FIGS. 1 and 11, may be implemented in hardware, software or a combination of both. The system is applicable to a wide variety of functions involving similar characteristics. The system is usable to provide an overview of items in adjacent windows without overly limiting the amount of items that can be shown.

What is claimed is:

1. A user interface system for use in managing orders for providing treatment for a patient, comprising:
a display processor for initiating generation of data representing a display image including,
a first user selectable image element indicating an order for a particular treatment to be provided to a particular patient is to be retained and
a second user selectable image element indicating said order for said particular treatment to be provided to said particular patient is to be revoked; and
an order processor for updating stored order representative records to indicate said order for said particular treatment to be provided to said particular patient is cancelled in response to user selection of said second user selectable image element.

2. A system according to claim 1, wherein
said first and second user selectable image elements are adjacent.

3. A system according to claim 1, wherein
said display image includes information indicating a potential clinical problem with said order.

4. A system according to claim 1, wherein
said display processor initiates generation of data representing said display image including said first and second user selectable image elements in response to user selection of a third image element in a different second image, said third image element initiating expansion of a collapsible image area.

5. A system according to claim 4, wherein
said display image includes a fourth image element indicating said collapsible image area is in at least one of, (a) a collapsed and (b) expanded, state.

6. A system according to claim 4, wherein
said collapsible image area is labeled to indicate existence of a potential clinical problem with said order for said particular treatment to be provided to said particular patient.

7. A system according to claim 4, wherein
said collapsible image area is labeled to indicate existence of a potential clinical problem with said order for said particular treatment to be provided to said particular patient and
in response to user selection of said third image element, said collapsible image area is expanded to show said display image identifying a potential clinical problem with said order.

8. A system according to claim 4, wherein
said potential problem comprises at least one of, (a) an order replication, (b) a medication dosage problem, (c) a medication interaction problem and (d) an inconsistency between patient medical data and prescribed medication.

9. A system according to claim 1, wherein
said first and second user selectable image elements are presented in a current order session window of said display image, said current order session window being used for showing orders to be placed in response to approval by a clinician.

10. A system according to claim 9, wherein
said display image includes a second window showing existing orders already approved by a clinician.

11. A system according to claim 10, wherein
said current order session window and said second window are adjacent in said display image.

12. A system according to claim 11, wherein
said current order session window and said second window each occupy substantially half the width of said available display image width.

13. A system according to claim 9, including
a movable selection list window providing information indicating treatment orders available for selection and incorporation in said current order session window.

14. A system according to claim 13, wherein
said current order session window and said selection list window are adjacent in said display image.

15. A system according to claim 14, wherein
said current order session window and said selection list window each occupy substantially half the width of said available display image width.

16. A user interface system for use in managing orders for providing treatment for a patient, comprising:
a display processor for initiating generation of data representing a display image including a current order session window identifying orders to be placed in response to approval by a clinician and including a collapsible image area including information identifying a potential clinical problem with an order for a particular treatment to be provided to a particular patient; and
an order processor for updating stored order representative records to indicate said order for said particular treatment to be provided to said particular patient is cancelled in response to user selection of a user selectable image element adjacent to said information identifying said potential clinical problem in said display image.

17. A system according to claim 16, wherein
user selection of a different image element in a different second image initiates expansion of said collapsible image area and said different image element is labeled to indicate existence of a potential clinical problem with an order for treatment to be provided to said particular patient.

18. A system according to claim 17, wherein
in response to user selection of said different image element, said collapsible image area is expanded to show said information identifying said potential clinical problem with said order.

19. A system according to claim 1, wherein
said display image includes a second window showing existing orders already approved by a clinician.

20. A system according to claim 19, wherein
said current order session window and said second window are adjacent in said display image.

21. A system according to claim 19, wherein
said current order session window and said second window each occupy substantially half the width of said available display image width.

22. A method for use in managing orders for providing treatment for a patient, comprising the activities of:
initiating generation of data representing a display image including,
a first user selectable image element indicating an order for a particular treatment to be provided to a particular patient is to be retained and
a second user selectable image element indicating said order for said particular treatment to be provided to said particular patient is to be revoked; and
updating stored order representative records to indicate said order for said particular treatment to be provided to said particular patient is cancelled in response to user selection of said second user selectable image element.

23. A tangible storage medium including machine readable instruction for executing the method of claim 22.

24. A method for use in managing orders for providing treatment for a patient, comprising the activities of:
initiating generation of data representing a display image including a current order session window identifying orders to be placed in response to approval by a clinician and including a collapsible image area including information identifying a potential clinical problem with an order for a particular treatment to be provided to a particular patient; and
updating stored order representative records to indicate said order for said particular treatment to be provided to said particular patient is cancelled in response to user selection of a user selectable image element adjacent to said information identifying said potential clinical problem in said display image.

25. A tangible storage medium including machine readable instruction for executing the method of claim 24.
